(19) United States
(12) Patent Application Publication
(10) Pub. No.: US 2025/0249424 A1
(43) Pub. Date: Aug. 7, 2025

(54) ELECTRICAL DISCHARGE PLASMA REACTION STRUCTURE WITH IMPROVED PROCESS STABILITY AND SELECTIVITY TOWARDS SHORT-CHAIN PFAS DEGRADATION

(71) Applicant: Gunnar Rohrman Stratton, Plymouth, CT (US)

(72) Inventor: Gunnar Rohrman Stratton, Plymouth, CT (US)

(21) Appl. No.: 18/433,441

(22) Filed: Feb. 6, 2024

(51) Int. Cl. B01J 19/08; C02F 1/46

(52) U.S. Cl. CPC B01J 19/088; C02F 1/4608; B01J 2219/0025; B01J 2219/00493; B01J 2219/0877; B01J 2219/0894

(57) ABSTRACT

Disclosed are embodiments of a reaction structure which has a gas phase electrode array integrated with defoamer, a container, a head space gas, bulk liquid, and a liquid phase electrode array with integrated gas bubbler, which emits process gas. There is a plasma discharge from the gas phase electrode array integrated with defoamer. The bulk liquid contains per- and polyfluoroalkyl substances (PFAS) chemicals, including short chain PFAS, which are degraded. In embodiments, a secondary plasma discharge can occur from the liquid phase electrode array with integrated gas bubbler. This secondary plasma discharge can be effective at degrading short-chain PFAS, which has a hard time gaining exposure to the plasma discharge formed from the gas phase electrode array integrated with defoamer. Also disclosed are embodiments of a process of use of the reaction structure to degrade PFAS.

### BACKGROUND OF THE INVENTION

The background of the invention is described in the following headings of the description, field of the invention, and description of the prior art.

### DESCRIPTION

Described are embodiments of a reaction structure which has a gas phase electrode array integrated with defoamer and liquid phase electrode array with integrated gas bubbler. There is a plasma discharge from the gas phase electrode array integrated with defoamer. Also, in embodiments of the reaction structure, there can be a secondary plasma discharge from the liquid phase electrode array with integrated gas bubbler. The secondary plasma discharge can occur at the tip of the tubes forming part of the liquid phase electrode array with integrated gas bubbler. The reaction structure contains water with unwanted chemicals, particularly per- and polyfluoroalkyl substances (PFAS) for degradation. The secondary plasma discharge at the tip of the tubes that form part of the liquid phase electrode array with integrated gas bubbler can be effective at degrading short chain PFAS.

### FIELD OF THE INVENTION

The field of the invention is reaction structures to process unwanted chemicals within a bulk liquid, and embodiments of the process of use of the reaction structures.

### DESCRIPTION OF THE PRIOR ART

Other reaction structures exist to process chemicals within liquids with the use of electrical discharges.

### BRIEF DESCRIPTION OF DRAWINGS

FIG. 1 is a front cut away view of an embodiment of the reaction structure with a gas phase electrode array integrated with defoamer.

FIG. 1A is a partial view of an embodiment of the gas phase electrode array integrated with defoamer showing that in some embodiments the component elements of the gas phase electrode array and the defoamer can be identified within the gas phase electrode array integrated with defoamer.

FIG. 2 is a top view of an embodiment of the reaction structure with a gas phase electrode array integrated with defoamer.

FIG. 3 is a side cut away view of an embodiment of the reaction structure with a gas phase electrode array integrated with defoamer.

FIG. 3A is a partial view of an embodiment of the gas phase electrode array integrated with defoamer and the distance of the gas phase electrode array integrated with defoamer above the bulk liquid surface.

FIG. 3B is a partial view of an embodiment of a liquid phase electrode with integrated gas bubbler and an array of tubes.

FIG. 4 is a side view of an embodiment of a liquid phase electrode with integrated gas bubbler with a manifold with Luer lock connectors attached to tubes, or needles, with corresponding Luer lock connector ends.

FIG. 5 is a top view of an embodiment of a tube second end and opening of the tube second end maximum diameter.

FIG. 6 is a top view of an embodiment of a tube second end and secondary plasma discharge from the curved tube second end.

FIG. 7 is a partial side view of an embodiment of a tube second end with the interface of a process gas bubble and bulk liquid and greater concentration of PFAS short chains compared to PFAS long chains.

FIG. 8 is a partial side view of an embodiment of the surface of the bulk liquid with a greater concentration of long chain PFAS as compared to short chain PFAS.

FIG. 9 is a perspective side view of an embodiment of a gas phase electrode array integrated with defoamer plate and mesh form, where the plate is porous metal, for a gas phase electrode array integrated with defoamer of a plurality of plates and mesh form.

FIG. 9A is a perspective side view of an embodiment of a gas phase electrode array integrated with defoamer plate and mesh form, where the plate is ceramic, for a gas phase electrode array integrated with defoamer of a plurality of plates and mesh form.

FIG. 10 is a front cut away view of an embodiment of the reaction structure with a gas phase electrode array integrated with defoamer of a plurality of plates and mesh form.

FIG. 11 is a top view of an embodiment of the reaction structure with a gas phase electrode array integrated with defoamer of a plurality of plates and mesh form.

FIG. 12 is a side cut away view of an embodiment of the reaction structure with a gas phase electrode array integrated with defoamer of a plurality of plates and mesh form.

FIG. 13 is a partial front cut away view of an embodiment of the reaction structure with a gas phase electrode array integrated with defoamer of a plurality of plates and mesh form, showing plasma from the gas phase electrode array integrated with defoamer of a plurality of plates and mesh form and the tube second ends of the liquid phase electrode with integrated gas bubbler.

FIG. 14 is a representation of an embodiment of a series of reaction structures.

FIG. 15 is a representation of an embodiment of reaction structures in parallel.

FIG. 16 is a representation of an embodiment of a reaction structure with short chain PFAS and long chain PFAS where the amount of short chain PFAS is 5 or more times more than the amount of long chain PFAS.

FIG. 17 is a representation of an embodiment of the process of using a process oriented reaction structure to degrade PFAS.

FIG. 18 is a representation of an embodiment of the process of using a process oriented reaction structure to degrade PFAS.

FIG. 19 is a representation of an embodiment of the process of using a process oriented reaction structure to degrade PFAS.

FIG. 20 is a representation of an embodiment of the process of using a process oriented reaction structure to degrade PFAS.

FIG. 21 is a representation of an embodiment of the process of using a process oriented reaction structure to degrade PFAS.

FIG. 22 is a representation of an embodiment of the process of using a process oriented reaction structure to degrade PFAS.

FIG. 23 is a representation of an embodiment of the process of using a process oriented reaction structure to degrade PFAS.

FIG. 24 is a representation of an embodiment of the process of using a process oriented reaction structure to degrade PFAS.

FIG. 25 is a front cut away view of an embodiment of the reaction structure with a gas phase electrode array and separate defoamer.

FIG. 26 is a top view of an embodiment of the reaction structure with a gas phase electrode array and separate defoamer.

FIG. 27 is a side cut away view of an embodiment of the reaction structure with a gas phase electrode array and separate defoamer.

### DETAILED DESCRIPTION OF THE INVENTION

Disclosed is a reaction structure 10 and the process of using the reaction structure for degradation of unwanted material or chemicals within a liquid. An example of unwanted material for degradation is per- and polyfluoroalkyl substances (PFAS).

An embodiment of the reaction structure 10 includes the elements of: gas phase electrode array integrated with defoamer 400; a head space gas 190; a bulk liquid 50; a container; liquid phase electrode with integrated gas bubbler 161, and a process gas 193. The reaction structure is configured for the process gas 193 is to be released from the liquid phase electrode with integrated gas bubbler 161 into the bulk liquid 50.

The reaction structure 10 uses electrically produced plasma 20 to degrade unwanted material in the bulk liquid 50. The electrically produced plasma is generated in the liquid phase (bulk liquid 50) and/or the gas phase (head space gas 190).

The defoaming ability of the gas phase electrode array integrated with defoamer 400 provides a stable treatment solution by annihilating the accumulated foam on the surface of the bulk liquid 50.

The gas phase electrode array integrated with defoamer 400 can also be called a gas phase electrode array with integrated defoamer.

An embodiment of a gas phase electrode array integrated with defoamer can include a porous metal plate 401 with a fine metal mesh 402 (approximately 1 mm grid) on the surface oriented towards the source of foam, and can be called a gas phase electrode array integrated with defoamer plate and mesh form 405. The fine metal mesh 402 can be substituted for mesh in general. The mesh can be configured as sections of mesh paired or attached to the plate. Both the plate and mesh can be stainless steel. In another embodiment, the plate can be a ceramic plate 406. The gas phase electrode array integrated with defoamer plate and mesh form 405 can be positioned a few mm above the surface of the bulk liquid and high voltage could be applied to generate plasma that would tend to originate from the mesh. In embodiments, plasma can form from any portion of the gas phase electrode array integrated with defoamer 400, so the plasma can come from a portion of the gas phase electrode array integrated with defoamer 400 which also is reducing bubbles or acting as a defoamer.

Also an embodiment of the gas phase electrode array integrated with defoamer 400 can include multiple porous metal plates with a fine metal mesh (approximately 1 mm grid) on the surface oriented towards the source of foam, and be called a gas phase electrode array integrated with defoamer of a plurality of plates and mesh form 403. The gas phase electrode array integrated with defoamer of a plurality of plates and mesh form 403 can be positioned where the multiple porous metal plates with a fine metal mesh are a few mm above the surface of the bulk liquid and high voltage could be applied to generate plasma that would tend to originate from the mesh on the multiple porous metal plates, and therefore the electrode element and the defoamer element can be one in the same.

The distance of the phase electrode array integrated with defoamer plate and mesh form 405 above the bulk liquid surface 81 is the distance each gas phase electrode array integrated with defoamer plate and mesh form is from the bulk liquid surface 47.

An embodiment of the gas phase electrode array integrated with defoamer 400 can include one element over the bulk liquid 50, such as one plate with mesh as in one gas phase electrode array integrated with defoamer plate and mesh form 405.

A benefit of implementing a gas phase electrode array integrated with defoamer 400 is the proximity of a defoaming ability (or in other words a defoamer) to the gas phase electrode array, which will decrease the chance of an excess of foam accumulating near the gas phase electrode array. The lack of foam near the gas phase electrode array allows process stabilization by ensuring that foam will not make sustained contact with the gas phase electrode and provide a conductive path to the bulk liquid surface and interfere with plasma formation. Also, if the gas phase electrode array and defoamer are separate objects, and the defoamer is a metallic object, it is suspected that this will decrease the effectiveness of the reaction structure 10, therefore the integration of the gas phase electrode and defoamer into one object can be beneficial. It is suspected that any extraneous object within the reaction structure 10 and in the head space gas 190, can cause a problem for the effectiveness of the reaction structure 10, especially if the extraneous object is metallic. Also a benefit of integration of the gas phase electrode and defoamer into one object is the simplicity associated with reducing the number of individual structures that must be contained in the reaction structure.

Whether or not foam is intentionally generated, foam often forms when a liquid is agitated and when the surface tension of the liquid is sufficiently low, as might occur when processing bulk liquid 50 in which surfactants such as PFAS 210 are present. Foam can interfere with the degradation process where the accumulated foam may provide a conductive channel between the gas phase electrode array integrated with defoamer 400 and the bulk liquid surface 81, which might inhibit formation of plasma at that gas phase electrode array integrated with defoamer 400. By decreasing the foam, the reaction structure 10 based around electrical discharge plasma can be employed for the treatment of liquids with any surfactant load without risking significant disruption due to accumulation of foam on the bulk liquid surface 81.

Also, foam can interfere with the degradation process by inhibiting the precise determination of liquid level by a sensor, thus hindering automatic maintenance of liquid level.

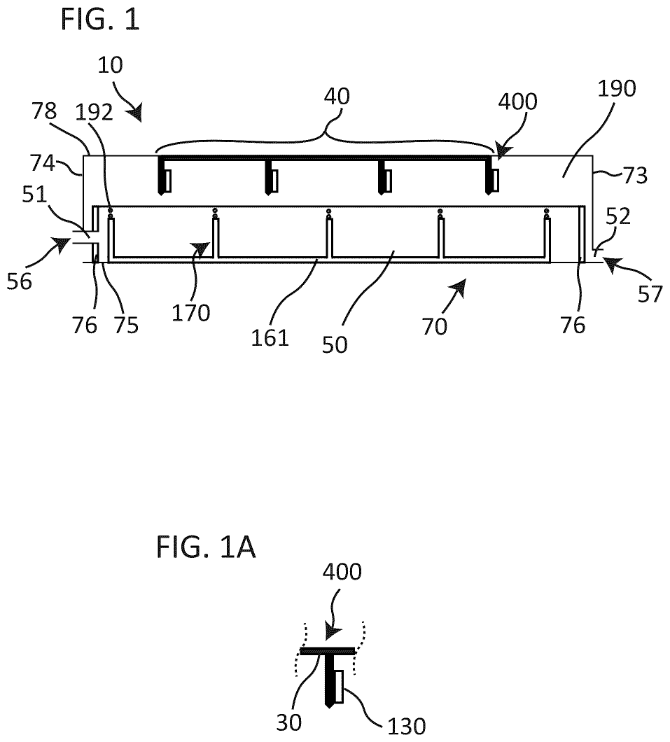

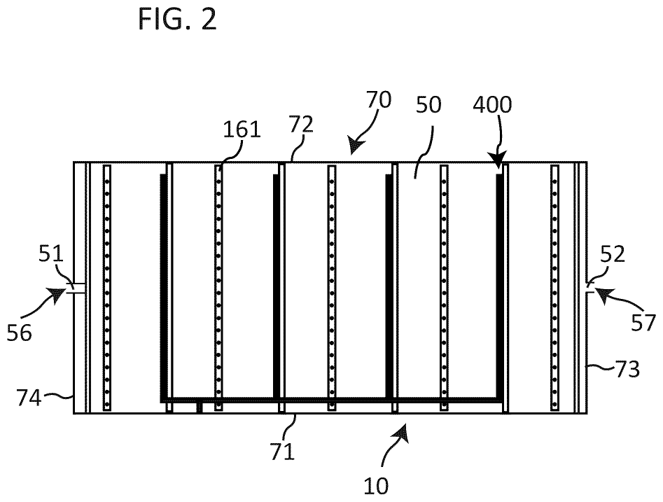

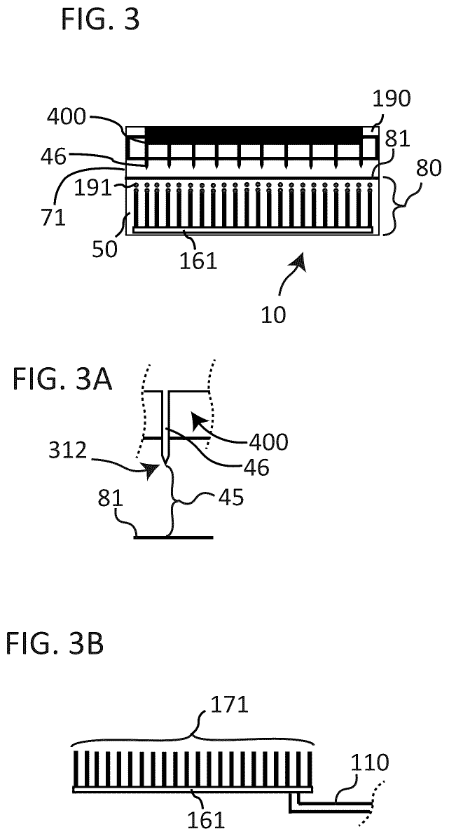

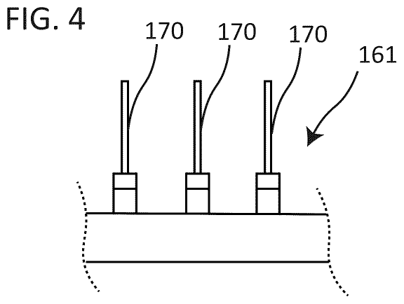

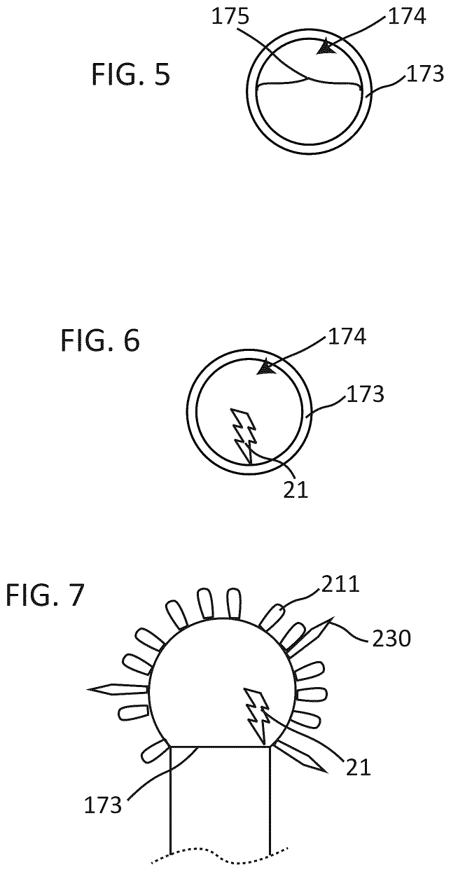

Another embodiment of the reaction structure 10, can take the form, as in FIGS. 1 and 1A, where near the surface of the bulk liquid 50 is the gas phase electrode array integrated with defoamer 400, and in that embodiment of the gas phase electrode array integrated with defoamer 400, the elements of the gas phase electrode array 30 and the defoamer 130 can be viewed as separate components identifiable within the gas phase electrode array integrated with defoamer 400.

An aerophilic defoamer, or element which acts as an aerophilic defoamer, can consist of materials that exhibit surface properties that help facilitate the collapse of bubbles and more rapidly defoams the surface. This will help to assure that foam does not build up in excessive quantities. Aerophilic defoamers could be constructed from inexpensive materials such as sintered metal coupled with fine mesh. A higher performance aerophilic defoamer can be fabricated by etching certain patterns onto the surface of a metal, however this is more expensive.

The defoamer 130 can also take the form of airborne ultrasonic irradiation. This would be more expensive to build and operate and would only be advised if foam accumulation is severely impacting performance of the reaction structure 10.

If the surface tension of the bulk liquid is particularly low due to higher surfactant concentrations, and no defoamer is able to moderate the accumulation of foam, the rate of process gas bubbling may be lowered.

In an embodiment of the reaction structure 10, the bulk liquid 50 is held in a container. The container is sealed so that the process gas 193 can be recycled and volatilized contaminants are not released into the ambient air.

The container can have different embodiments. One embodiment is a rectangular container 70, which tends to be easiest to scale. The rectangular container 70 has a rectangular container front side 71, rectangular container rear side 72, rectangular container right side 73, rectangular container left side 74, and rectangular container top side 78. Embodiments of the rectangular container 70 can be a large basin which is: 1.5 to 3 meters in length for the rectangular container front side 71 and rectangular container rear side 72; and 1 to 2 meters in length for the rectangular container right side 73 and rectangular container left side 74. The rectangular container front side 71, rectangular container rear side 72, rectangular container right side 73, and rectangular container left side 74 form the side walls of the rectangular container 70. The rectangular container front side 71, rectangular container rear side 72, rectangular container right side 73, and rectangular container left side 74 are approximately 50 cm in height. The rectangular container top side 78 seals of the reaction structure 10 so process gas 193 can be recycled and volatilized contaminants are not released into the ambient air. The bottom of the rectangular container 70 is formed by a rectangular container bottom side 75.

In embodiments of the reaction structure 10, the bulk liquid 50 is held at a constant height of approximately 15 cm in depth. The bulk liquid depth 80 (depth of the bulk liquid) can also be 2-500 mm in depth, in other embodiments.

In embodiments of the reaction structure 10, the bulk liquid 50 can be exchanged where there is entering bulk liquid 51, exiting bulk liquid 52, a bulk liquid entry section 56, and bulk liquid exit section 57. The entering bulk liquid 51 enters the container through the bulk liquid entry section 56 and the exiting bulk liquid 52 exits the container through the bulk liquid exit section 57.

The bulk liquid entry section 56 can also be called the bulk liquid entry section of the container. The bulk liquid exit section 57 can also be called bulk liquid exit section of the container.

This exchange of bulk liquid can be alternatively described as the bulk liquid entry section of the container is configured to hold bulk liquid which can enter the container, also called entering bulk liquid 51; and the bulk liquid exit section of the container is configured to hold bulk liquid which can exit the container, also called exiting bulk liquid 52.

In an embodiment of the reaction structure 10, the entering bulk liquid 51 is pumped into the container.

In an embodiment of the container, the constant height of the bulk liquid 50 can be maintained by the use of a weir 76. The weir 76 is part of the container. The entering bulk liquid 51 enters the container within part of the container where the height of the bulk liquid is defined by the weir 76. The bulk liquid 50 spills over the top of the weir. Then the exiting bulk liquid 52 exits the container through the bulk liquid exit section 57.

An alternative to using a weir 76 to maintain the bulk liquid level can be utilizing variations in the rate of the pumping in and/or pumping out of the bulk liquid 50. This strategy would be more effectively employed if in combination with a liquid level sensor.

The gas phase electrode array integrated with defoamer 400 can have multiple embodiments. An example of an embodiment of the gas phase electrode array integrated with defoamer 400 is rows of conductive material running from front to rear of the rectangular container 70.

The gas phase electrode array integrated with defoamer 400 is positioned over the bulk liquid 50. The gas phase electrode array integrated with defoamer 400 can be positioned in the head space gas 190. An embodiment of the gas phase electrode array integrated with defoamer 400 consists of some electrically conductive objects or arrays of objects. The gas phase electrode array integrated with defoamer 400 will undergo gradual erosion, involving sputtering of microscopic particles of the material into the bulk liquid 50.

Some embodiments of the gas phase electrode array integrated with defoamer 400 might be constructed with inert materials.

For embodiments of the gas phase electrode array integrated with defoamer 400, while common metals like stainless steel can suffice, the generation of electrical discharge plasma will cause deterioration of the electrode, so use of a high-durability material, such as tungsten, copper tungsten or tungsten carbide is advised to reduce maintenance requirements. However, in the case that the particular water contaminant being treated is sufficiently vulnerable to catalytic reactions, a material that possesses the appropriate catalytic activity could be used, with the expectation that particles of this material will be sputtered into the liquid during operation, and will help to increase net degradation reaction rates.

The gas phase electrode array integrated with defoamer 400 in some embodiments will be positioned where the closest part of the gas phase electrode array integrated with defoamer 400 is 2-25 mm above the bulk liquid surface 81. If an embodiment of the gas phase electrode array integrated with defoamer 400 has points, each point 46 has a tip of the point 312, and the distance each of the tips of the points is from the bulk liquid surface 45 is 2-25 mm. Some embodiments of the gas phase electrode array integrated with defoamer 400 can be something like a saw blade, or a series of sharp points, or a rod, or a mesh or a wire. A useable shape of the gas phase electrode array integrated with defoamer 400 allows for generation of plasma that is evenly distributed over the surface of the bulk liquid.

The gas phase electrode array integrated with defoamer 400 can be described as having a series of rows of conductive material with a plurality of points protruding from the rows 40.

Embodiments of the gas phase electrode array integrated with defoamer 400 can be platinum or palladium, which have broader catalytic applicability, but might be cost-prohibitive unless their impact on treatment is sufficiently high.

An embodiment of the gas phase electrode array integrated with defoamer 400 has sections, which are the elements which can be viewed as forming rows. The sections can have a series of points or teeth along the length of the section. The ideal distance between the sections within the gas phase electrode array integrated with defoamer 400 depends on the length of the plasma channels, as it is most efficient to expose the highest possible fraction of the bulk liquid surface to the plasma. The channel length is primarily dependent on applied voltage, discharge energy and liquid conductivity. Therefore, the optimal distance between sections within the gas phase electrode array integrated with defoamer 400 must be determined in relation to the chosen applied voltage, discharge energy and the conductivity of the bulk liquid.

High voltage (tens of thousands of volts) will be applied to the gas phase electrode array integrated with defoamer 400 to generate plasma, which will originate at the electrode and propagate down to the bulk liquid surface, and then spread in the direction of the liquid phase electrode with integrated gas bubbler 161. The high voltage applied to the gas phase electrode array integrated with defoamer 400 will be in the form of pulsed capacitor discharges. The gas phase electrode array integrated with defoamer 400 will be induced to generate plasma via the application of pulsed AC at voltages ranging from (−) 60,000 V to (+) 60,000 V.

Also, embodiments of the reaction structure 10 can include a voltage multiplier which has a single or dual polarity output.

Embodiments of the reaction structure 10 can contain a liquid level sensor, to maintain the setpoint level of the bulk liquid, although embodiments with a liquid level sensor is not ideal when plasma is used in the reaction structure 10.

The liquid phase electrode with integrated gas bubbler 161 is within the bulk liquid. The liquid phase electrode with integrated gas bubbler 161 consists of electrically conductive material. Process gas 193 is released from the liquid phase electrode with integrated gas bubbler 161 into the bulk liquid 50. The process gas 193 enters the liquid phase electrode with integrated gas bubbler 161 and the process gas 193 exits into the bulk liquid 50 as process gas bubbles 192.

In an embodiment of the reaction structure 10 the liquid phase electrode array with integrated gas bubbler 161 is positioned where sections of the liquid phase electrode array with integrated gas bubbler 161 are arranged equidistant from the two neighboring sections of the gas phase electrode array integrated with defoamer 400, which helps facilitate the even distribution of plasma on the surface of the bulk liquid. The sections of the liquid phase electrode array with integrated gas bubbler 161 are elements which can be viewed as forming rows.

Embodiments of the liquid phase electrode array with integrated gas bubbler 161 can be nickel or iron, which are generally more catalytically active materials. Embodiments of the liquid phase electrode array with integrated gas bubbler 161 constructed from materials that exhibit some catalytic properties that can be activated by the high electrical currents that pass across their surfaces may facilitate intense electrochemical reactions that occur on their surfaces which can increase treatment rates.

In an embodiment of a liquid phase electrode with integrated gas bubbler 161 the process gas 193 is released from a tube 170. Embodiments can include an array of tubes 171 which is formed from tubes. Each tube 170 is arranged along a section of the liquid phase electrode with integrated gas bubbler 161 to form the array of tubes 171. Each tube 170 has a tube first end 172 and a tube second end 173. The tube first end 172 is attached to the liquid phase electrode with integrated gas bubbler 161. The process gas 193 enters the tube first end 172 and exits the tube second end 173 to enter the bulk liquid 50. The process gas 193 exists in the bulk liquid 50 as process gas bubbles 192.

The tube second end 173 has an opening of the tube second end 174. The opening of the tube second end 174 has an opening of the tube second end maximum diameter 175. The opening of the tube second end maximum diameter 175 is measured as the opening or inside diameter of the opening of the tube second end 174 in a direction which will give a maximum distance across the opening of the tube second end 174 from one point of the tube second end 173 to another point on the tube second end 173. Embodiments of the opening of the tube second end maximum diameter 175 can be 0.5 mm to 5 mm. The opening of the tube second end 174 in most embodiments will be a circular profile, but other profiles can exist.

Embodiments of the array of tubes 171 are where each tube 170 is vertically oriented, or perpendicular to the surface of the bulk liquid, where the tube first end 172 is closer to the bottom of the container and the tube second end 173 is closer to the surface of the bulk liquid. Additionally, such embodiments could have the tube second end 173 within a few centimeters of the surface of the bulk liquid.

An effective and convenient embodiment of the liquid phase electrode with integrated gas bubbler 161 can incorporate a manifold with multiple Luer lock connection points. The manifold can be a section of the liquid phase electrode with integrated gas bubbler 161. Depending upon the chosen length and diameter of the tubes 170, an appropriate compatible fitting, such as a Luer lock dispensing needle fitting could form a connection from a male portion protruding from the manifold and a female portion at the tube first end 172 forming a connection point. If an inert material such as stainless steel is to be used, these components are readily available, but if a catalytically active material is specified, the components will need to be custom built from these materials, or available components must be coated with these materials using some method such as physical vapor deposition or electroplating.

The small diameter of the tubes will induce modifications to the electric field such that plasma discharges are generated at the tube second end 173. The small diameter will help to induce electric field curvature for the purpose of generating plasma discharges originating at the tube second ends 173. This discharge at the tube second end 173 can be called a secondary plasma discharge 21 and is a unique feature disclosed, in combination with other elements of the reaction structure 10, such as the defoaming quality of the gas phase electrode array integrated with defoamer 400, and for the use of degradation of PFAS and especially short-chain PFAS.

The specific inner and outer diameters of the tubes will be largely dependent upon the conductivity of the bulk liquid 50. Higher conductivities will necessitate smaller tube diameters in order to generate plasma. Smaller diameter tubes will erode more quickly as a result of the plasma discharge, which increases maintenance requirements. Thus, use of the largest diameter tube that still reliably generates plasma at the relevant range of liquid conductivities is advised.

In variable embodiments of the reaction structure 10, the plasma discharges originating from the tube second ends 173 will be induced incidentally (secondary discharge), due to the application of high voltage to the gas phase electrode array integrated with defoamer 400. Plasma discharges originating from the tube second ends 173 can alternatively occur by application of high voltage directly to the liquid phase electrode with integrated gas bubbler 161. If inducing plasma discharges via incidental field derived from voltage applied to the gas phase electrode array integrated with defoamer 400, then the liquid phase electrode with integrated gas bubbler 161 may be connected to electrical ground 110. If inducing plasma discharges via direct application of high voltage to the liquid phase electrode with integrated gas bubbler 161, it is suggested that the polarity of such voltage is opposite that applied to the gas phase electrode array integrated with defoamer 400. Additionally, the discharge energies should be equal and discharges from the two electrode arrays should be synchronized, otherwise a dedicated grounded electrode must also be situated within the bulk liquid, between the tube second ends 173 and the surface of the bulk liquid.

The release of process gas 193 from the liquid phase electrode with integrated gas bubbler 161 allows for the generation of plasma, as a secondary discharge from tube second ends 173, even when the conductivity of the bulk liquid is high. Without the release of process gas 193 released from the liquid phase electrode with integrated gas bubbler 161, as the conductivity of the bulk liquid 50 increases, it will become increasingly difficult to generate plasma, as a secondary discharge, at the tube second ends 173, given no corresponding increases in the voltages applied. To overcome this, a controllable valve and manifold assembly allows for process argon gas 191, or any other appropriate process gas 193, to be pumped through the tubes 170 of the liquid phase electrode with integrated gas bubbler 161. The process gas 193 emitted from the tube second ends 173 will assure that plasma, as a secondary discharge, can still be generated there even at high bulk liquid 50 conductivities.

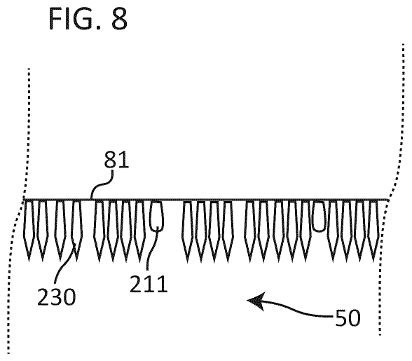

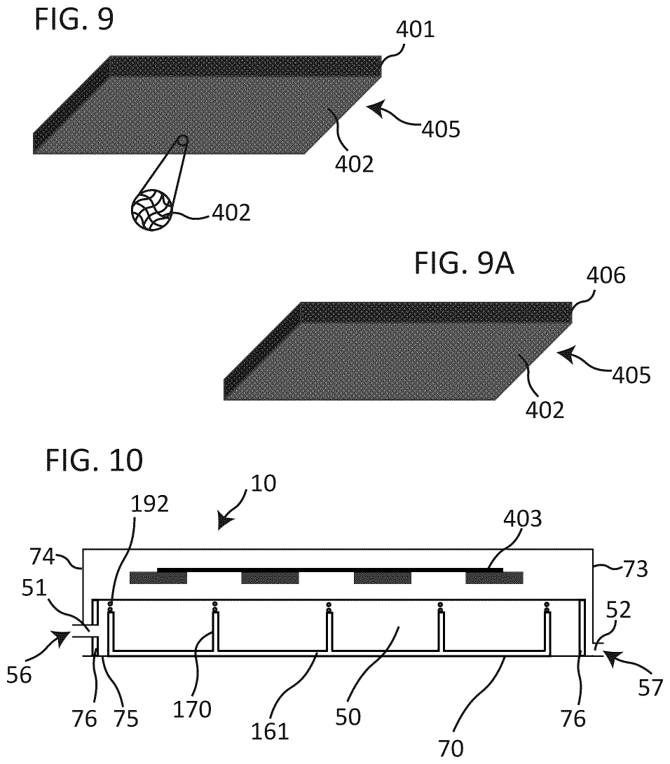

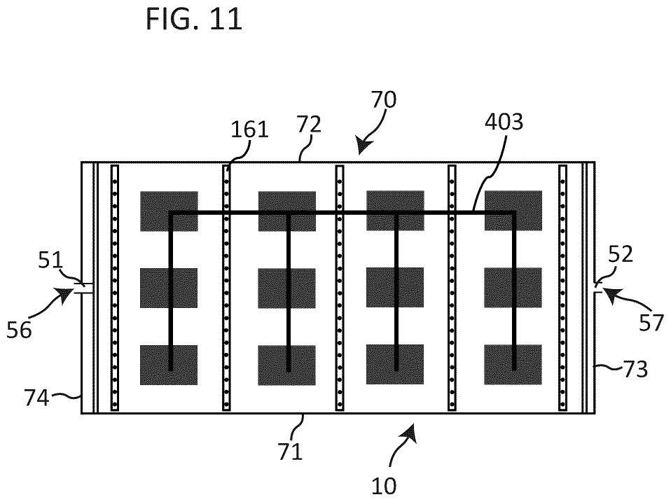

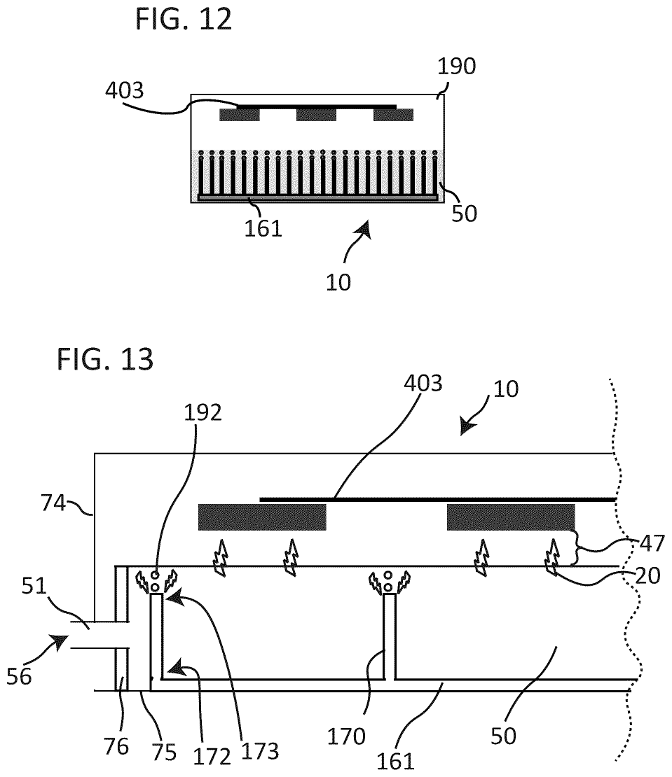

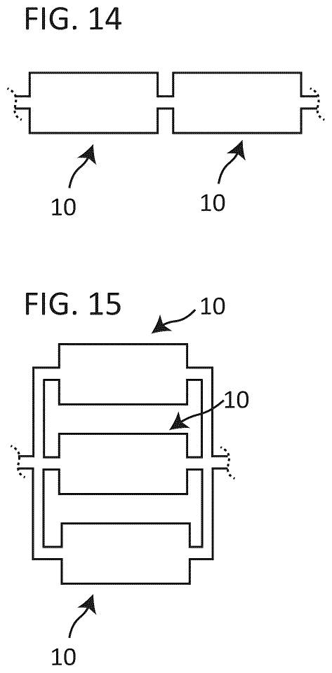

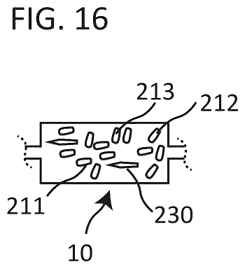

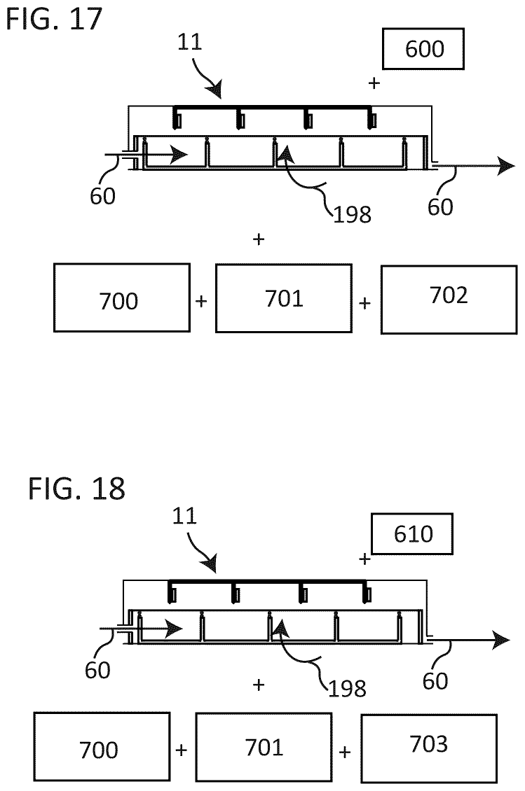

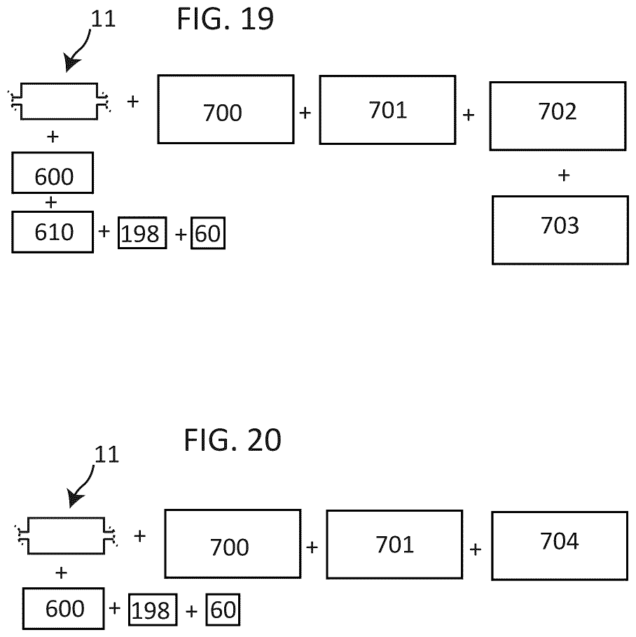

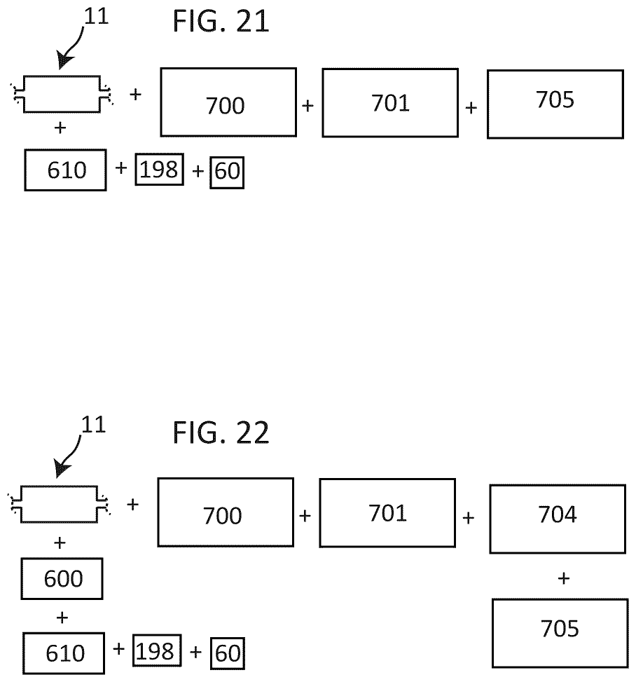

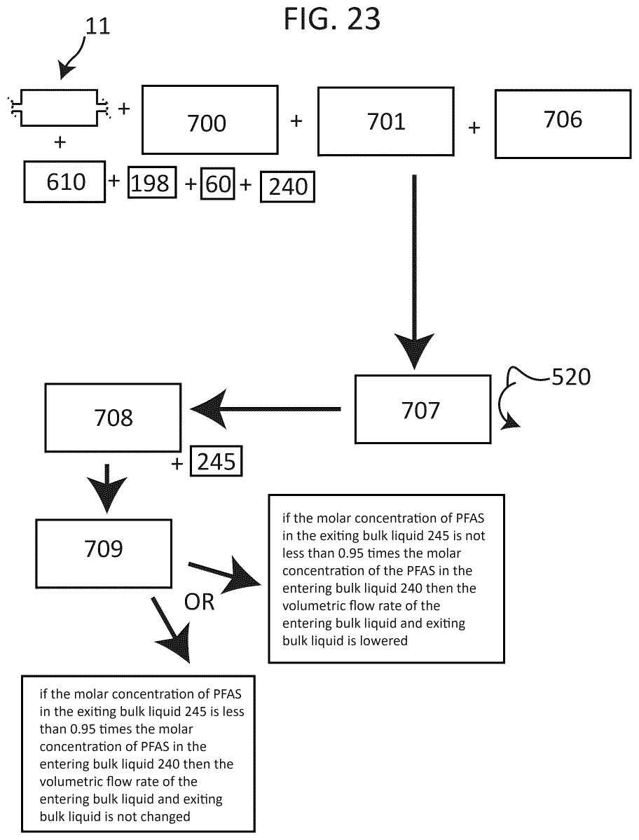

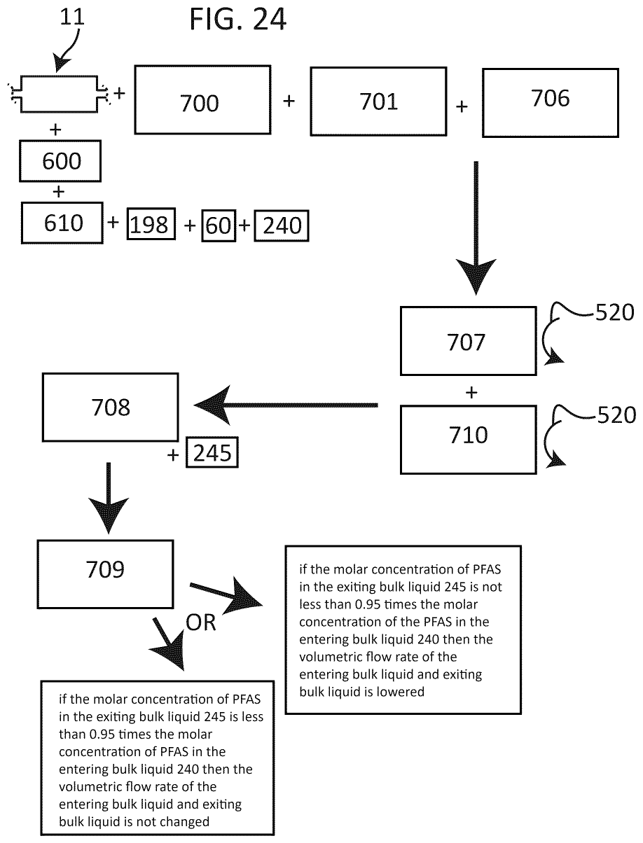

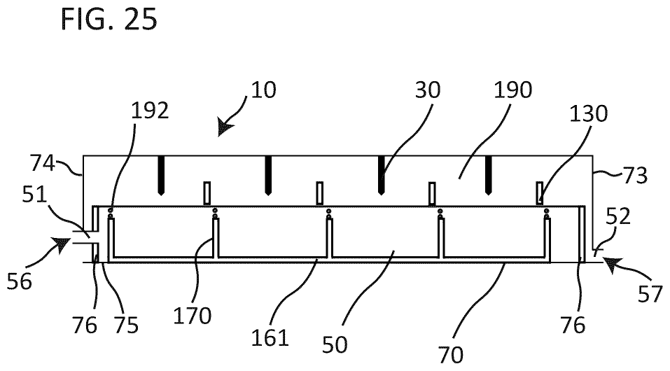

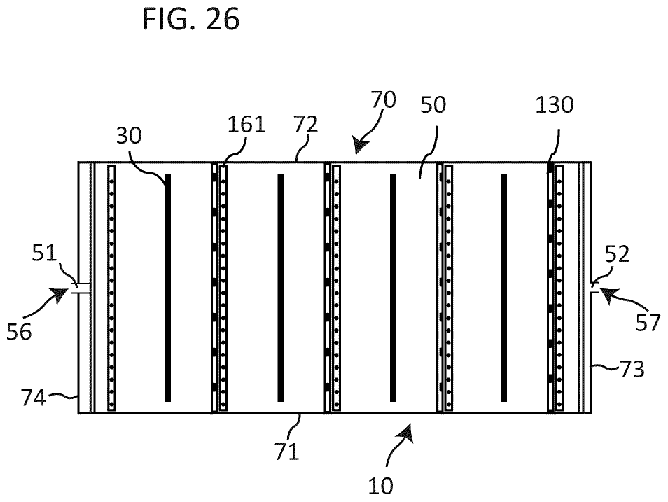

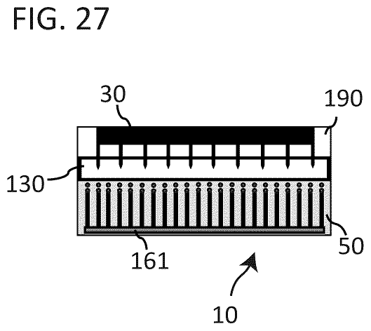

Therefore, process gas 193 injected into the bulk liquid 50 through the tubes 170 on the liquid phase electrode with integrated gas bubbler 161 can be utilized to generate a secondary plasma discharge at the tube second end 173. The process gas 193 will be in the bulk liquid 50 as process gas bubbles 192 that emerge from the opening of the tube second ends 174 and will help to potentiate secondary plasma discharges in high conductivity bulk liquid 50. These secondary discharges in the bulk liquid 50 will help to degrade chemicals with lower surface activity that are not as concentrated at the surface in the region contacted by the plasma formed from the gas phase electrode array integrated with defoamer 400, which is the bulk liquid surface 81. PFAS short chains 211 can also be called short chain PFAS. PFAS long chains 230 can also be called long chain PFAS. Short chain PFAS have a lower surface activity and thus will occupy a larger portion of the interface of the process gas bubble 192 in the bulk liquid 50 compared to the interface between the head space gas 190 and bulk liquid 50, because the process gas bubbles 192 are constantly formed giving the interface less time to become saturated with long chain PFAS prior to formation of plasma. Therefore the plasma at the interface of the bubbles will treat higher concentrations of PFAS short chains than the plasma formed at the interface of the head space gas 190 and bulk liquid 50. FIG. 7 shows the higher amount of PFAS short chains 211 at the interface of the process gas bubble 192 in the bulk liquid 50. FIG. 8 shows the higher amount of PFAS long chains 230 at the interface of the head space gas 190 and bulk liquid 50.

In an embodiment of the reaction structure 10, the process gas 193 is process argon gas 191. Process argon gas 191 can also be called argon.

The bulk liquid 50 can consist of whatever liquid one wants to be treated by the plasma. Upon the exiting bulk liquid 52 leaving the reaction structure 10 (or multiple reaction structures), the liquid may be pumped out of the treatment facility as treated effluent.

The depth of bulk liquid 50 is a design variable that directly influences the overall electrical resistance of the water layer. Greater depth produces higher resistance, which may be beneficial for the purpose of lengthening discharge time and potentially increasing plasma streamer length, which is correlated with higher treatment efficiency. However, greater depth also reduces relative mixing rates in the bulk liquid 50, which can have a detrimental effect on treatment efficiency. The appropriate depth will vary depending on other treatment factors, but the depth must be sufficient to create some barrier to stifle direct arcing between the gas phase and liquid phase electrode arrays.

Multiple reaction structures can be connected together. The connection of the reaction structures can be connected in a series or in parallel. There can also be a connection of reaction structures 10 in a combination of series and/or in parallel.

The head space gas 190 can consist of any gas that has a sufficiently low ionization energy to allow for the formation of plasma with reasonable applied voltage.

The process gas 193 can be argon gas, or also called process argon gas 191. Argon is an ideal process gas, as it, 1) has a low ionization energy, allowing for more efficient plasma formation; 2) is a noble gas, so it won't undergo permanent chemical changes during the process, allowing it to be reused; 3) is non-toxic; and 4) is cheap and commonly available. Occasionally other process gases may be used such as air or oxygen (O2), as these are converted into plentiful reactive species, which aids in the treatment of contaminants that are susceptible to oxidation. However, the most promising application of this system is for treatment of PFAS 210, which are highly resistant to oxidation. Thus, descriptions of phenomena and performance pertain primarily for the use of argon as the process gas.

In embodiments of the reaction structure 10 the bulk liquid 50 can include a varying mixture of PFAS short chains 211 and PFAS long chains 230. Specific examples of PFAS types are: PFOA, PFOS, PFNA, PFHxS, PFBS and HFPO-DA.

The plasma generated from the gas phase electrode array integrated with defoamer 400 propagates over the surface of the bulk liquid 50 and is highly effective and efficient for degrading contaminants that concentrate at the gas-liquid interface, such as surfactants. Additionally, these discharges generate highly reactive chemical species that diffuse some distance into the bulk liquid 50 and thus are able to react with contaminants that don't concentrate as much at the interface; however, these secondary reactions are typically less effective and primarily occur if the contaminants that are present are vulnerable to oxidation. Therefore, the discharges from the gas phase electrode array integrated with defoamer 400 are far less efficient for the degradation of PFAS short chains 211, such as PFBA 212 and PFBS 213, which are highly resistant to oxidation and not highly prone to concentrating at the gas-liquid interface at the bulk liquid surface 81.

This selectivity is possibly problematic due to the likelihood of the USEPA issuing maximum contaminant levels (MCLs) for some shorter-chain PFAS alongside the MCLs for the longer-chain PFAS that are so efficiently degraded by the plasma formed from the gas phase electrode array integrated with defoamer 400. A complete treatment solution for PFAS will include treatment of long and shorter chain PFAS. Additionally, when the longer-chain PFAS are degraded at the gas-liquid interface, their byproducts are less surface active, and thus are less likely to receive further treatment by plasma at the surface, which ultimately reduces the overall degree of mineralization.

The plasma generated from the liquid phase electrode with integrated gas bubbler 161, at the tube second end 173, is intrinsically less selective than that from the gas phase electrode array integrated with defoamer 400, as it interacts with the contaminants at their bulk or near-bulk concentrations. This relatively non-selective treatment avenue reduces the selectivity of the entire system, thus increasing its versatility and applicability to water contaminated with shorter-chain PFAS, as well as any other non-surfactant contaminants. Similarly, this also increases the degree of mineralization. The secondary discharge at the liquid phase electrode with integrated gas bubbler 161, at the tube second end 173 is used specifically to increase degradation rates for chemicals that have a lower tendency to concentrate at the surface of the bulk liquid.

A bulk liquid 50 where the amount of PFAS short chains 211 is 5 or more times the amount of PFAS long chains 230, can be considered a bulk liquid 50 with a high concentration of PFAS short chains 211 relative to PFAS long chains 230. The amount of the PFAS short chains 211 and PFAS long chains 230 can be measured as the concentration of each in the bulk liquid such as molarity, or a molar concentration. Therefore, a bulk liquid 50 where the molar concentration of PFAS short chains 211 is 5 or more times the molar concentration of PFAS long chains 230, can be considered a bulk liquid 50 with a high concentration of PFAS short chains 211 relative to PFAS long chains 230.

In an embodiment of the reaction structure 10, the liquid phase electrode array with integrated gas bubbler 161 is attached directly to the ground 110.

An embodiment of the process for using the reaction structure 10 for treating contaminated bulk liquid can exist.

In the embodiment of the process for using the reaction structure 10 for treating contaminated bulk liquid, the PFAS-contaminated bulk liquid enters into the reaction structure 10 in the bulk liquid entry section 56 and exits the reaction structure 10 from the bulk liquid exit section 57 where the volumetric flow rate that has been determined appropriate based on prior testing (this is dependent upon the initial concentrations of PFAS 210 present in the bulk liquid 50 and the desired reduction in concentrations as well as other properties such as the electrical conductivity of the bulk liquid 50, the size and quantity of bulk liquid 50 in the reactor structure 10 employed, the electrical power available for input, or other factors). The volumetric flow rate of the entering bulk liquid and exiting bulk liquid 60, is the amount of the bulk liquid 50 processed in a certain period of time.

In the embodiment of the process for using the reaction structure 10 for treating contaminated bulk liquid, the input of process gas 193 can occur in the process. The process gas 193 will enter the bulk liquid 50 at a volumetric flow rate of the process gas 198, which is the amount of process gas 193 entering the bulk liquid 50 in a certain time (or stated another way, rate of flow of the process gas through the liquid phase electrode with integrated gas bubbler 161 and therefore into the bulk liquid 50). The volumetric flow rate of the process gas 198 is determined by prior testing. The volumetric flow rate of the process gas 198, among other factors, is dependent upon the concentration of PFAS 210 in the bulk liquid 50, as this is the dominant factor in foam stability. If PFAS concentrations are so high that the defoaming ability of the gas phase electrode array integrated with defoamer 400 is unable to keep up, then the volumetric flow rate of the process gas 198 must be reduced.

The distance between the liquid surface and the gas phase electrode array integrated with defoamer 400 should be set to between 2 and 25 mm, but will depend upon the concentration of PFAS, as this will determine the height of bubbles formed on the bulk liquid surface.

In an embodiment of the process for using the reaction structure 10 for treating contaminated bulk liquid, high voltage is applied to either the gas phase electrode array integrated with defoamer 400, liquid phase electrode with integrated gas bubbler 161, or both. The application of voltage to a particular electrode depends upon prior testing and is determined by the concentrations of each of the PFAS species of interest and the desired concentrations of those species after treatment. For instance, if treating a bulk liquid 50 with no presence of very short chain PFAS (or no desire to remove those present), but an abundance of long chain PFAS, the plasma formed from the liquid phase electrode is less important, as it primarily helps to increase short-chain PFAS degradation, thus the high voltage may only be applied to the gas phase electrode array. However, if the bulk liquid 50 has an abundance of short chain PFAS that must be degraded, it will be beneficial to apply the high voltage to the liquid phase electrode array, or to apply high voltage to both electrode arrays, though in this case the voltage must be of opposing polarities. The specific characteristics of this high voltage may vary depending on what is best for the particular application, but typically it will consist of capacitor discharges at a frequency between 0.01 and 100 kHz, and a voltage of 10,000-100,000 Volts.

Site characterization that is performed prior to the initiation process for using the reaction structure 10 for treating contaminated bulk liquid will determine how frequently and to what degree the concentrations of the different PFAS species vary. This will in turn determine the frequency with which the entering bulk liquid 51 is tested during treatment to quantify concentrations of the PFAS species of interest. Prior testing will determine the bottleneck species, that is, the species of interest (of interest meaning that it must be removed) that takes the longest treatment time to reduce concentrations to desired levels. The concentration of this bottleneck species will determine the required treatment time, which in turn determines the volumetric flow rate of the entering bulk liquid and exiting bulk liquid 60.

In embodiments of the process of using the reaction structure 10 for degradation of PFAS 210 there is volumetric flow rate of the entering bulk liquid and exiting bulk liquid 60. The volumetric flow rate of the entering bulk liquid and exiting bulk liquid 60 is the rate of flow of bulk liquid 50 through the reaction structure 10, such as 5 L/minute, or 5 L of bulk liquid 50 entered the reaction structure 10 and 5 L of bulk liquid 50 exited the reaction structure 10.

In embodiments of the process of using the reaction structure 10 for degradation of PFAS 210 there is volumetric flow rate of the process gas 198. The volumetric flow rate of the process gas 198 is the rate of flow of the process gas through the liquid phase electrode with integrated gas bubbler 161 and therefore into the bulk liquid 50. The volumetric flow rate of the process gas 198, for instance, can be 4 L/minute, or 4 L of process gas 193 will enter the liquid phase electrode with integrated gas bubbler 161 and then exit the liquid phase electrode with integrated gas bubbler 161 and then enter the bulk liquid 50.

In embodiments of the process of using the reaction structure 10 for degradation of PFAS 210 there is a gas phase electrode array integrated with defoamer voltage 600. The gas phase electrode array integrated with defoamer voltage 600 is applied to the gas phase electrode array integrated with defoamer 400. The gas phase electrode array integrated with defoamer voltage 600 can consist of capacitor discharges at a frequency between 0.01 and 100 kHz, and a voltage of 10,000-100,000 Volts.

In embodiments of the process of using the reaction structure 10 for degradation of PFAS 210 there is a liquid phase electrode array with integrated gas bubbler voltage 610. The liquid phase electrode array with integrated gas bubbler voltage 610 is applied to the liquid phase electrode with integrated gas bubbler 161. The liquid phase electrode array with integrated gas bubbler voltage 610 can consist of capacitor discharges at a frequency between 0.01 and 100 kHz, and a voltage of 10,000-100,000 Volts.

The application of a voltage can be described as: application of the gas phase electrode array integrated with defoamer voltage to the gas phase electrode array integrated with defoamer 702; and application of the liquid phase electrode array with integrated gas bubbler voltage to the liquid phase electrode array with integrated gas bubbler 703.

The application of a voltage can be described where there are particular qualities of the voltage: application of the gas phase electrode array integrated with defoamer voltage to the gas phase electrode array integrated with defoamer the gas phase electrode array integrated with defoamer voltage is applied in a range of 10,000 to 100,000 Volts and at a frequency of 0.01 to 100 kHz 704; and application of the liquid phase electrode array with integrated gas bubbler voltage to the liquid phase electrode array with integrated gas bubbler the liquid phase electrode array with integrated gas bubbler voltage is applied in a range of 10,000 to 100,000 Volts and at a frequency of 0.01 to 100 kHz 705.

In embodiments of the process of using the reaction structure 10 for degradation of PFAS 210 there can be testing of the amount of degradation of PFAS 210 within the bulk liquid 50. There is a molar concentration of PFAS in the entering bulk liquid 240. Also, there is a molar concentration of PFAS in the exiting bulk liquid 245. There is a testing time. The molar concentration of PFAS in the entering bulk liquid 240 and molar concentration of PFAS in the exiting bulk liquid 245 is determined before the application of a voltage, which is applied for the testing time 520. And, the molar concentration of PFAS in the entering bulk liquid 240 and molar concentration of PFAS in the exiting bulk liquid 245 is determined after the application of a voltage for the testing time.

Also an embodiment of the process can be where the molar concentration of PFAS in the entering bulk liquid 240 is determined before the application of a voltage, which is applied for the testing time 520. Also an embodiment of the process can be where the molar concentration of PFAS in the exiting bulk liquid 245 is determined after the application of a voltage for the testing time.

If the molar concentration of PFAS in the exiting bulk liquid 245 is decreased by a certain amount such as the molar concentration of PFAS in the exiting bulk liquid 245 is less than 0.95 times the molar concentration of PFAS in the entering bulk liquid 240, then this can be considered sufficient for showing degradation of PFAS 210 at a high enough amount. Although in many instances, the desired reduction in PFAS is almost complete removal, so the PFAS is reduced by 99.999%, or to even undetectable levels. If degradation of PFAS 210 is at a high enough amount the volumetric flow rate of the entering bulk liquid and exiting bulk liquid 60 is not changed. If degradation of PFAS 210 is not at a high enough amount, such as the molar concentration of PFAS in the exiting bulk liquid 245 is not decreased by a certain amount such as the molar concentration of PFAS in the exiting bulk liquid 245 is equal to or above 0.95 times the molar concentration of PFAS in the entering bulk liquid 240, then the volumetric flow rate of the entering bulk liquid and exiting bulk liquid 60 is lowered.

Embodiments of the process of use can be alternatively described.

An embodiment of the reaction structure with the following characteristics, can be called a process oriented reaction structure 11. The process oriented reaction structure 11 comprises a gas phase electrode array integrated with defoamer 400, a bulk liquid 50, head space gas 190, a container, the container holds the bulk liquid 50, a liquid phase electrode array with integrated gas bubbler 161, a process gas 193, the process gas 193 is released from the liquid phase electrode array with integrated gas bubbler 161 into the bulk liquid 50, a bulk liquid entry section 56, entering bulk liquid 51, a bulk liquid exit section 57, exiting bulk liquid 52, the entering bulk liquid 51 enters the container through the bulk liquid entry section 56 and the exiting bulk liquid 52 exits the container through the bulk liquid exit section 57, an array of tubes, each tube has first end and a second end, the first end of each tube is connected to the gas bubbler, process gas released from the gas bubbler enters the first end of the tubes and exits the second end of the tubes, an opening of the second end of each tube, the opening of the second end of each tube has a maximum diameter, the maximum diameter of the opening of the second end of each tube is 0.5 mm to 5 mm, the bulk liquid 50 contains PFAS 210.

The process can include other embodiments of the reaction structure 10 described.

Embodiments of the process of use will have a gas phase electrode array integrated with defoamer voltage 600 and/or a liquid phase electrode array with integrated gas bubbler voltage 610, depending on which is applied. Embodiments of the process of use will have a volumetric flow rate of the entering bulk liquid and exiting bulk liquid 60 and a volumetric flow rate of the process gas 198.

An embodiment of the process of use can be: a process oriented reaction structure 11; application of a volumetric flow rate of the entering bulk liquid and exiting bulk liquid 700; application of a volumetric flow rate of the process gas 701; and application of the liquid phase electrode array with integrated gas bubbler voltage to the liquid phase electrode array with integrated gas bubbler 703.

An embodiment of the process of use can be: a process oriented reaction structure 11; application of the volumetric flow rate of the entering bulk liquid and exiting bulk liquid 700; application of the volumetric flow rate of the process gas 701; and application of the gas phase electrode array integrated with defoamer voltage to the gas phase electrode array integrated with defoamer 702.

An embodiment of the process of use can be: a process oriented reaction structure 11; application of the volumetric flow rate of the entering bulk liquid and exiting bulk liquid 700; application of the volumetric flow rate of the process gas 701; application of the gas phase electrode array integrated with defoamer voltage to the gas phase electrode array integrated with defoamer 702; and application of the liquid phase electrode array with integrated gas bubbler voltage to the liquid phase electrode array with integrated gas bubbler 703.

An embodiment of the process of use can be: a process oriented reaction structure 11; application of the volumetric flow rate of the entering bulk liquid and exiting bulk liquid 700; application of the volumetric flow rate of the process gas 701; and application of the gas phase electrode array integrated with defoamer voltage to the gas phase electrode array integrated with defoamer where the gas phase electrode array integrated with defoamer voltage is applied in a range of 10,000 to 100,000 Volts and at a frequency of 0.01 to 100 kHz 704.

An embodiment of the process of use can be: a process oriented reaction structure 11; application of the volumetric flow rate of the entering bulk liquid and exiting bulk liquid 700; application of the volumetric flow rate of the process gas 701; and application of the liquid phase electrode array with integrated gas bubbler voltage to the liquid phase electrode array with integrated gas bubbler where the liquid phase electrode array with integrated gas bubbler voltage is applied in a range of 10,000 to 100,000 Volts and at a frequency of 0.01 to 100 kHz 705.

An embodiment of the process of use can be: a process oriented reaction structure 11; application of the volumetric flow rate of the entering bulk liquid and exiting bulk liquid 700; application of the volumetric flow rate of the process gas 701; application of the gas phase electrode array integrated with defoamer voltage to the gas phase electrode array integrated with defoamer where the gas phase electrode array integrated with defoamer voltage is applied in a range of 10,000 to 100,000 Volts and at a frequency of 0.01 to 100 kHz 704; and application of the liquid phase electrode array with integrated gas bubbler voltage to the liquid phase electrode array with integrated gas bubbler where the liquid phase electrode array with integrated gas bubbler voltage is applied in a range of 10,000 to 100,000 Volts and at a frequency of 0.01 to 100 kHz 705.

An embodiment of the process of use can be: a process oriented reaction structure 11; application of the volumetric flow rate of the entering bulk liquid and exiting bulk liquid 700; application of the volumetric flow rate of the process gas 701; determination of the molar concentration of PFAS in the entering bulk liquid 706; then the application of the gas phase electrode array integrated with defoamer voltage in a range of 10,000 to 100,000 Volts and at a frequency of 0.01 to 100 kHz for the testing time 707; then determination of the molar concentration of PFAS in the exiting bulk liquid 708; then comparison of the molar concentration of PFAS in the entering bulk liquid to the molar concentration of PFAS in the exiting bulk liquid 709; then if the molar concentration of PFAS in the exiting bulk liquid is less than 0.95 times the molar concentration of PFAS in the entering bulk liquid then the volumetric flow rate of the entering bulk liquid and exiting bulk liquid is not changed; and if the molar concentration of PFAS in the exiting bulk liquid is not less than 0.95 times the molar concentration of the PFAS in the entering bulk liquid then the volumetric flow rate of the entering bulk liquid and exiting bulk liquid is lowered.

An embodiment of the process of use can be: a process oriented reaction structure 11; application of the volumetric flow rate of the entering bulk liquid and exiting bulk liquid 700; application of the volumetric flow rate of the process gas 701; determination of the molar concentration of PFAS in the entering bulk liquid 706; then the application of the gas phase electrode array integrated with defoamer voltage in a range of 10,000 to 100,000 Volts and at a frequency of 0.01 to 100 kHz for the testing time 707 and application of the liquid phase electrode array with integrated gas bubbler voltage in a range of 10,000 to 100,000 Volts and at a frequency of 0.01 to 100 kHz for the testing time 710; then determination of the molar concentration of PFAS in the exiting bulk liquid 708; then comparison of the molar concentration of PFAS in the entering bulk liquid to the molar concentration of PFAS in the exiting bulk liquid 709; then if the molar concentration of PFAS in the exiting bulk liquid is less than 0.95 times the molar concentration of PFAS in the entering bulk liquid then the volumetric flow rate of the entering bulk liquid and exiting bulk liquid is not changed and if the molar concentration of PFAS in the exiting bulk liquid is not less than 0.95 times the molar concentration of the PFAS in the entering bulk liquid then the volumetric flow rate of the entering bulk liquid and exiting bulk liquid is lowered.

In another embodiment of the reaction structure 10 includes the main elements of: a gas phase electrode array 30; a head space gas 190; a bulk liquid 50; a container; a defoamer 130; and liquid phase electrode with integrated gas bubbler 161. In this embodiment the defoamer 130 is separate from the gas phase electrode array 30.

In an embodiment of the process for using the reaction structure 10 for treating contaminated bulk liquid, where the embodiment of the reaction structure 10 has a defoamer 130 that is separate from the gas phase electrode array 30, the high voltage is applied to either the gas phase electrode array 30, the liquid phase electrode with integrated gas bubbler 161, or both electrode arrays.

The present invention is not limited to the above described embodiments. The above described embodiments are merely illustrative and other variations and modifications may be possible without departing from the scope of the present invention.

1. An apparatus comprising,
a gas phase electrode array integrated with defoamer,
a bulk liquid,
head space gas,
a container, the container holds the bulk liquid,
a liquid phase electrode array with integrated gas bubbler,
a process gas, the apparatus is configured to have the process gas released from the liquid phase electrode array with integrated gas bubbler into the bulk liquid.

2. An apparatus as in claim 1, further comprising,
per- and polyfluoroalkyl substances,
the bulk liquid contains per- and polyfluoroalkyl substances.

3. An apparatus as in claim 2, further comprising,
a molar concentration of short chain per- and polyfluoroalkyl substances in the bulk liquid,
a molar concentration of long chain per- and polyfluoroalkyl substances in the bulk liquid,
the molar concentration of short chain per- and polyfluoroalkyl substances in the bulk liquid is 5 or more times as much as the molar concentration of long chain per- and polyfluoroalkyl substances in the bulk liquid.

4. An apparatus as in claim 1, comprising,
the gas phase electrode array integrated with defoamer is configured to reduce bubbles as an aerophilic defoamer.

5. An apparatus as in claim 1, further comprising,
a plate,
a section of mesh,
the plate and the section of mesh form a portion of the gas phase electrode array integrated with defoamer.

6. An apparatus as in claim 1, further comprising,
an array of tubes, the array of tubes form a portion of the liquid phase electrode array with integrated gas bubbler, each tube has a first end and a second end, the first end of each tube is connected to the liquid phase electrode array with integrated gas bubbler, the liquid phase electrode array with integrated gas bubbler is configured for the process gas to be released from the liquid phase electrode array with integrated gas bubbler where process gas enters the first end of the tubes and exits the second end of the tubes.

7. An apparatus as in claim 6, further comprising,
an opening of the second end of each tube,
a maximum diameter of the opening of the second end of each tube,
the maximum diameter of the opening of the second end of each tube is 0.5 mm to 5 mm.

8. An apparatus as in claim 7, further comprising,
entering bulk liquid, the entering bulk liquid is a portion of the bulk liquid, a bulk liquid entry section of the container, the bulk liquid entry section of the container is configured to hold the entering bulk liquid,
exiting bulk liquid, the exiting bulk liquid is a portion of the bulk liquid, a bulk liquid exit section of the container, the bulk liquid exit section of the container is configured to hold the exiting bulk liquid,
per- and polyfluoroalkyl substances,
the bulk liquid contains per- and polyfluoroalkyl substances.

9. An apparatus as in claim 7, further comprising,
per- and polyfluoroalkyl substances,
the bulk liquid contains per- and polyfluoroalkyl substances,
a molar concentration of short chain per- and polyfluoroalkyl substances in the bulk liquid,
a molar concentration of long chain per- and polyfluoroalkyl substances in the bulk liquid,
the molar concentration of short chain per- and polyfluoroalkyl substances in the bulk liquid is 5 or more times as much as the molar concentration of long chain per- and polyfluoroalkyl substances in the bulk liquid.

10. An apparatus as in claim 9, comprising,
the gas phase electrode array integrated with defoamer is configured to reduce bubbles as an aerophilic defoamer.

11. An apparatus as in claim 9, further comprising,
a plate, the plate is ceramic or porous metal,
a section of metal mesh,
the plate and the section metal mesh form a portion of the gas phase electrode array integrated with defoamer.

12. An apparatus as in claim 11, further comprising,
a plurality of plates,
a plurality of sections of metal mesh, each section of metal mesh is attached to a plate.

13. An apparatus as in claim 12, further comprising,
a bulk liquid surface,
a closest portion of each of the sections of metal mesh to the bulk liquid surface, a distance of the closest portion of each of the sections of metal mesh to the bulk liquid surface is from the bulk liquid surface,
the distance of the closest portion of each of the sections of metal mesh to the bulk liquid surface is from the bulk liquid surface is 2 to 25 mm,
a depth of the bulk liquid,
the depth of the bulk liquid is 2 to 500 mm.

14. An apparatus as in claim 9, further comprising,
the gas phase electrode array integrated with defoamer is configured to reduce bubbles as an aerophilic defoamer,
a series of rows of conductive material,
a plurality of points, the plurality of points protrude from the series of rows of conductive material,
the series of rows of conductive material forms a portion of the gas phase electrode array integrated with defoamer,
a bulk liquid surface,
a tip of each of the points,
a distance of the tip of each of the points is from the bulk liquid surface, the distance each of the points is from the bulk liquid surface is 2 to 25 mm, a depth of the bulk liquid,
the depth of the bulk liquid is 2 to 500 mm.

15. A process comprising,
an apparatus, comprising,
a gas phase electrode array integrated with defoamer,
a bulk liquid,
head space gas,
a container, the container holds the bulk liquid,
a liquid phase electrode array with integrated gas bubbler,
a process gas,
entering bulk liquid, the entering bulk liquid is a portion of the bulk liquid,
a bulk liquid entry section of the container, the bulk liquid entry section of the container is configured to hold the entering bulk liquid,
exiting bulk liquid, the exiting bulk liquid is a portion of the bulk liquid,
a bulk liquid exit section of the container, the bulk liquid exit section of the container is configured to hold the exiting bulk liquid,
an array for tubes, each tube has a first end and a second end, the first end of each tube is connected to the liquid phase electrode array with integrated gas bubbler,
the liquid phase electrode array with integrated gas bubbler is configured for the process gas to be released from the liquid phase electrode array with integrated gas bubbler where process gas enters the first end of the tubes and exits the second end of the tubes,
an opening of the second end of each tube,
a maximum diameter of the opening of the second end of each tube,
the maximum diameter of the opening of the second end of each tube is 0.5 mm to 5 mm,
per- and polyfluoroalkyl substances,
the bulk liquid contains per- and polyfluoroalkyl substances,
a volumetric flow rate of the entering bulk liquid and exiting bulk liquid, application of the volumetric flow rate of the entering bulk liquid and exiting bulk liquid,
a volumetric flow rate of the process gas, application of the volumetric flow rate of the process gas,
a gas phase electrode array integrated with defoamer voltage, the gas phase electrode array integrated with defoamer voltage is applied to the gas phase electrode array integrated with defoamer.

16. The process as in claim 15, further comprising,
a liquid phase electrode array with integrated gas bubbler voltage, the liquid phase electrode array with integrated gas bubbler voltage is applied to the liquid phase electrode array with integrated gas bubbler.

17. The process as in claim 15, comprising,
the gas phase electrode array integrated with defoamer voltage is applied in a range of 10,000 to 100,000 Volts and at a frequency of 0.01 to 100 kHz.

18. The process as in claim 16, comprising,
the gas phase electrode array integrated with defoamer voltage is applied in a range of 10,000 to 100,000 Volts and at a frequency of 0.01 to 100 kHz,
the liquid phase electrode array with integrated gas bubbler voltage is applied in a range of 10,000 to 100,000 Volts and at a frequency of 0.01 to 100 KHz.

19. The process as in claim 17, further comprising,
a molar concentration of per- and polyfluoroalkyl substances in the entering bulk liquid,
a molar concentration of per- and polyfluoroalkyl substances in the exiting bulk liquid,
the molar concentration of per- and polyfluoroalkyl substances in the entering bulk liquid is determined before the gas phase electrode array integrated with defoamer voltage is applied to the gas phase electrode array integrated with defoamer, a testing time,
then the gas phase electrode array integrated with defoamer voltage is applied to the gas phase electrode array integrated with defoamer for the testing time,
then the molar concentration of per- and polyfluoroalkyl substances in the exiting bulk liquid is determined,
then the molar concentration of per- and polyfluoroalkyl substances in the entering bulk liquid is compared to the molar concentration of per- and polyfluoroalkyl substances in the exiting bulk liquid,
then if the molar concentration of per- and polyfluoroalkyl substances in the exiting bulk liquid is less than 0.95 times the molar concentration of per- and polyfluoroalkyl substances in the entering bulk liquid then the volumetric flow rate of the entering bulk liquid and exiting bulk liquid is not changed and if the molar concentration of per- and polyfluoroalkyl substances in the exiting bulk liquid is not less than 0.95 times the molar concentration of per- and polyfluoroalkyl substances in the entering bulk liquid then the volumetric flow rate of the entering bulk liquid and exiting bulk liquid is lowered.

20. The process as in claim 18, further comprising,
a molar concentration of per- and polyfluoroalkyl substances in the entering bulk liquid,
a molar concentration of per- and polyfluoroalkyl substances in the exiting bulk liquid,
the molar concentration of per- and polyfluoroalkyl substances in the entering bulk liquid is determined before the gas phase electrode array integrated with defoamer voltage is applied to the gas phase electrode array integrated with defoamer and the liquid phase electrode array with integrated gas bubbler voltage is applied to the liquid phase electrode array with integrated gas bubbler,
a testing time,
then the gas phase electrode array integrated with defoamer voltage is applied to the gas phase electrode array integrated with defoamer for the testing time and the liquid phase electrode array with integrated gas bubbler voltage is applied to the liquid phase electrode array with integrated gas bubbler for the testing time,
then the molar concentration of per- and polyfluoroalkyl substances in the exiting bulk liquid is determined,
then the molar concentration of per- and polyfluoroalkyl substances in the entering bulk liquid is compared to the molar concentration of per- and polyfluoroalkyl substances in the exiting bulk liquid,
then if the molar concentration of per- and polyfluoroalkyl substances in the exiting bulk liquid is less than 0.95 times the molar concentration of per- and polyfluoroalkyl substances in the entering bulk liquid then the volumetric flow rate of the entering bulk liquid and exiting bulk liquid is not changed and if the molar concentration of per- and polyfluoroalkyl substances in the exiting bulk liquid is not less than 0.95 times the molar concentration of the per- and polyfluoroalkyl substances in the entering bulk liquid then the volumetric flow rate of the entering bulk liquid and exiting bulk liquid is lowered.
